(19) United States
(12) Patent Application Publication
(10) Pub. No.: US 2026/0071061 A1
(43) Pub. Date: Mar. 12, 2026

(54) ARTICLES COMPRISING NON-PFAS ELASTOMER COMPOSITIONS AND THE METHODS OF PREPARING SAME

(71) Applicant: Greene, Tweed Technologies, Inc., Wilmington, DE (US)

(72) Inventors: Mookkan Periyasamy, Wilmington, DE (US); Ronald R. Campbell, Loudon, TN (US); AA. Mubasshir, Rangpur (BD); Vincent McGlynn, Langhorne, PA (US)

(73) Assignee: Greene, Tweed Technologies, Inc., Wilmington, DE (US)

(21) Appl. No.: 19/318,905

(22) Filed: Sep. 4, 2025

Related U.S. Application Data
(60) Provisional application No. 63/691,637, filed on Sep. 6, 2024.

(51) Int. Cl. C08L 23/0869; B29C 37/00; B29C 48/00; B29C 48/79; B29C 71/02; B29K 19/00; B29K 23/00; B29L 31/26; C08K 3/34; C08K 5/00; C08K 5/09; C08L 15/00; C08L 23/16

(52) U.S. Cl. CPC C08L 23/0869; B29C 48/022; B29C 48/79; B29C 71/02; C08K 3/34; C08K 5/0016; C08K 5/0025; C08K 5/005; C08K 5/09; C08L 15/005; C08L 23/16; B29C 2037/90; B29K 2019/00; B29K 2023/08; B29K 2023/16; B29L 2031/26; C08J 2315/00; C08J 2323/08; C08J 2323/16; C08L 2205/025; C08L 2205/035; C08L 2205/06

(57) ABSTRACT

Articles may include at least non-PFAS elastomers and additives. The non-PFAS elastomers may include at least one of polyacrylate elastomer (ACM), polyethylene acrylate elastomer (AEM), ethylene propylene diene monomers (EPDM) elastomer, ethylene propylene monomers (EPM), nitrile butadiene rubbers (NBR) and hydrogenated nitrile butadiene rubbers (HNBR) elastomer. Under a six-hour remote NF₃ plasma exposure at 150° C., the non-PFAS elastomers may have a weight change less than or equal to about 2%. The additives may include fillers, which include at least one of carbon black, silicon carbide, silica, barium sulfate, carbon, clay, talc, metallic fillers, metallic nitrides, and/or organic fillers. The organic fillers may include polyether ether ketone (PEEK), polyaryl ether ketone (PAEK), or nylon. The non-PFAS elastomer may have a weight percentage from about 25% to about 99%. The additives have a weight percentage from about 1% to about 67%.

### CROSS-REFERENCE TO RELATED APPLICATIONS

This application claims the benefit of U.S. Provisional Application No. 63/691,637 filed on Sep. 6, 2024, the entire contents of which is incorporated herein by reference.

### BACKGROUND

Seals are known for various applications, for example, for use in preventing leakage, containing pressure, or excluding contamination. Seals typically incorporate one or more sealing rings and are employed in various industries, such as the fluid handling, aerospace and semiconductor areas. In the semiconductor areas, there are sealing assemblies for doors and gates between various reaction chambers in semiconductor processing equipment in the microchip manufacturing area. There are also seals for use in various assemblies employed in manufacturing support systems, for example in a “subfab” environment, such as incoming delivery conduit for reactants, air handling conduits, and exhaust vacuum system piping.

Seals may be manufactured using elastomers, which are polymers that typically have viscoelasticity, weak intermolecular forces, generally low Young's modulus and high failure strain compared with other materials. Commonly used elastomers include polyfluoroalkyl substances (PFAS) elastomers. Since PFAS raises global concern on human health regarding long-term impact of exposure to some PFAS, seals with good thermal, physical, mechanical, or other properties constructed with a non-PFAS elastomer are desired. The inventions disclosed herein relate to an improved seal that with a non-PFAS elastomer having certain properties and characteristics that provide enhanced performance.

### SUMMARY

An article may include at least a non-PFAS elastomer and one or more additives. The non-PFAS elastomer may include at least one of a polyacrylate elastomer (ACM), a polyethylene acrylate elastomer (AEM), ethylene propylene monomers (EPM), an ethylene propylene diene monomers (EPDM) elastomer, a nitrile butadiene rubbers (NBR) and a hydrogenated nitrile butadiene rubbers (HNBR) elastomer. Under a six-hour remote NF₃ plasma exposure, the non-PFAS elastomers may have a weight change less than or equal to about 2%. The additives may include fillers, which include at least one of carbon black, silicon carbide, silica, barium sulfate, carbon, clay, talc, metallic fillers, metallic nitrides, and/or organic fillers. The organic fillers may include polyether ether ketone (PEEK), polyaryl ether ketone (PAEK), or nylon. The non-PFAS elastomer may have a weight percentage from about 25% to about 99% in the article. The additives may have a weight percentage from about 1% to about 67% in the article.

The additives may include one or more of a curative, a coagent, a cure accelerator, a processing aid, a plasticizer, a modifier, a colorant, an organic dye and/or a pigment.

A method of forming an article between a first component and a second component may include compressing a sealing composition which includes the non-PFAS elastomer and the additives between the first component and the second component.

The AEM elastomer structure may have an ethylene monomer repeat unit, a substituted or unsubstituted alkylacrylate monomer repeat unit, and a cure site monomer unit, as shown in general structure (M¹):

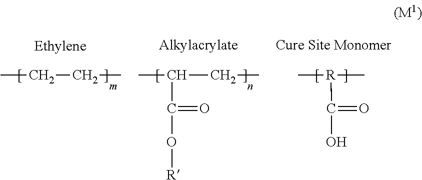

R may represent a moiety selected from a substituted or unsubstituted butanoic acid monoalkylester moiety. R′ may represent a moiety selected from the group consisting of substituted or unsubstituted C₁-C₁₂ alkyl. The first number of the ethylene monomer repeat unit may be from about 25 wt % to about 60 wt %. The second number of the alkylacrylate monomer repeat unit may be from about 40 wt % to about 75 wt %.

The ACM elastomer may have an ethylacrylate monomer repeat unit and a second repeat unit (e.g., repeat unit m and repeat unit n) as shown in general structure (M³):

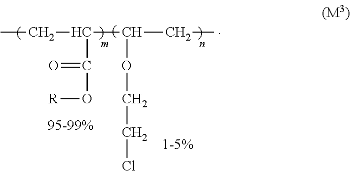

R may represent a moiety selected from the group consisting of substituted or unsubstituted C₁-C₁₂ alkyl. The number of the ethylacrylate repeat unit m may be from about 95 wt % to about 99 wt %. The number of the repeat unit n may be from about 1 wt % to about 5 wt %.

The HNBR elastomer structure may have a first repeat unit and a second repeat unit (e.g., repeat unit m and repeat unit n) as shown in general structure (M⁴):

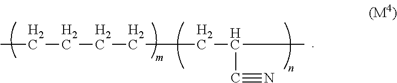

The number of the repeat unit m may be from about 50 wt % to about 85 wt %. The number of the repeat unit n may be from about 15 wt % to about 50 wt %.

The NBR elastomer structure may have a first repeat unit and a second repeat unit (e.g., repeat unit n and repeat unit m) as shown in general structure (M⁵):

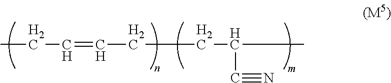

The number of the repeat unit m may be from about 18 wt % to about 50 wt %. The number of the repeat unit n may be from about 50 wt % to about 82 wt %.

The EPDM elastomer may have an ethylene monomer repeat unit, a propylene monomer repeat unit, and a diene monomer unit as shown in general structure (M⁶):

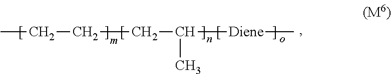

wherein the diene monomer repeat unit may include a substituted or unsubstituted ethylidene norbornene (ENB) monomer repeat unit, a substituted or unsubstituted dicyclopentadiene (DCPD) monomer repeat unit, a substituted or unsubstituted vinyl norbornene (VNB) monomer repeat unit, and/or a substituted or unsubstituted 1, 4 hexadiene (1,4 HD) monomer repeat unit. A first number of the ethylene monomer repeat unit may be from about 45 mol % to about 85 mol %. A second number of the propylene monomer repeat unit may be from about 15 mol % to about 55 mol %. A third number of the diene monomer unit may be from about 1 mol % to about 12 mol %.

The EPM elastomer may have an ethylene monomer repeat unit, and a propylene monomer repeat unit as shown in general structure (M⁷):

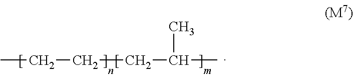

A first number of the ethylene monomer repeat unit may be from about 40 mol % to about 80 mol %. A second number of the propylene monomer repeat unit may be from about 20 mol % to about 60 mol %

An H₂O outgas behavior of the article may be less than or equal to about 8.65*10⁻⁸ mbar*l/s/cm². An organic volatile outgas behavior of the article may be less than or equal to about 1.01*10⁻⁸ mbar*l/s/cm². An organic non-volatile outgas behavior of the article may be less than or equal to about 2.47*10⁻⁹ mbar*l/s/cm².

A remote NF₃ plasma resistance of the article may include a percentage of weight change less than or equal to about 1.88%

The article may be an O-ring, a T-seal, a gasket, a D-ring, a Quad ring, and/or a custom-shaped seal.

A manufacturing method of an article may include conducting a first vacuum bakeout of a two-step vacuum bakeout process on non-PFAS elastomers to remove volatiles from the non-PFAS elastomers. The manufacturing method may include mixing the non-PFAS elastomers with one or more of a curative, a co-curative, or fillers in an internal mixer or a two-roll rubber mill to form non-PFAS compounds. The manufacturing method may include mixing one or more of processing aids, colorants, or antioxidants with the non-PFAS compounds. The manufacturing method may include conducting a second vacuum bakeout process of the two-step vacuum bakeout process on the non-PFAS compounds to remove volatiles from the non-PFAS compounds. The article may be an O-ring, a T-seal, a gasket, a D-ring, a Quad ring, and/or a custom-shaped seal.

In various embodiments described herein, the manufacturing method may include testing the non-PFAS elastomers, the non-PFAS compounds, and/or parts having the non-PFAS compounds for outgassing.

Residual gas released from the non-PFAS compound may include organic volatiles in millibar per second per square centimeter less than or equal to about 5.2*10⁻⁸ (mbar*l/s/cm²) as measured by an outgassing test. Preferably, residual gas released from the non-PFAS compound may include organic volatiles in millibar per second per square centimeter less than or equal to about 2.17*10⁻¹⁰ (mbar*l/s/cm²) as measured by an outgassing test.

Residual gas released from the non-PFAS compound may include organic non-volatiles in millibar per second per square centimeter less than or equal to about 1.42*10⁻⁷ (mbar*l/s/cm²) as measured by an outgassing test. Preferably, residual gas released from the non-PFAS compound may include organic non-volatiles in millibar per second per square centimeter less than or equal to about 5.00*10⁻¹² (mbar*l/s/cm²) as measured by an outgassing test.

### BRIEF DESCRIPTION OF THE DRAWINGS

FIG. 1 is a flow diagram illustrating an example of the compounding process starting with 100 grams of non-PFAS material for making parts with non-PFAS elastomers.

### DETAILED DESCRIPTION

### Terms and Concepts

As used herein, the following terms have the following meanings unless expressly stated to the contrary.

As used herein, the term “about”, in the context of concentrations of components of the formulations or in property values, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

When values are expressed as approximations, by use of the antecedent “about,” it will be understood that the particular value forms another example.

All ranges are inclusive and combinable. In addition, when a range is recited, it is contemplated that all values within the range, including end points, are combinable in all possible combinations.

As used herein, the term “wt %” refers to weight percentage. The weight percentage of a component equals a ratio of a mass of a component to the total mass of the whole compound or product.

As used herein, the term “mol %” refers to mole fraction or mole percentage. The mole fraction of a component equals a ratio of number of moles of a component to the total number of moles of the whole compound.

Unless otherwise specified, percentages are by weight percent (wt %) rather than volume present.

As used herein, the term “non-PFAS compound” refers to a blended mixture of non-PFAS elastomer, fillers, and additives.

As used herein, the term “PFAS compound” refers to a blended mixture of PFAS elastomer, fillers, and additives.

As used herein, the term “AEM compound” refers to a blended mixture of AEM elastomer, fillers, and additives. A constructed example of “AEM compound” is specified as set for in paragraph 146 of this specification.

As used herein, the term “ACM compound” refers to a blended mixture of ACM elastomer, fillers, and additives. A constructed example of “ACM compound” is specified as set for in paragraph 165 of this specification.

As used herein, the term “EPDM compound” refers to a blended mixture of EPDM elastomer, fillers, and additives. A constructed example of “EPDM compound” is specified as set for in paragraph 170 of this specification.

As used herein, the term “HNBR compound” refers to a blended mixture of HNBR elastomer, fillers, and additives. Constructed examples of “HNBR compound” are specified as set for in paragraphs 153 and 160 of this specification. As used herein, the term “HNBR compound recipe 1001189” refers to a constructive example of Greene Tweed® recipe 1001189 HNBR compound specified as set for in paragraph 153 of this specification. As used herein, the term “HNBR compound recipe 1000597” refers to a constructive example of Greene Tweed® recipe 1000597 HNBR compound specified as set for in paragraph 160 of this specification.

As used herein, the term “parts with non-PFAS elastomer” refers to parts manufactured with a non-PFAS elastomer by for example: (1) preforming or extruding the non-PFAS compound into desired shapes and (2) molding the non-PFAS compound in desired shapes. For example, “parts with non-PFAS elastomer” is renamed as “O-rings with non-PFAS elastomer” if the desired shape is O-ring or halved O-ring.

As used herein, the term “parts with PFAS elastomer” refers to parts manufactured with a PFAS elastomer by for example: (1) preforming or extruding the PFAS compound into desired shapes and (2) molding the PFAS compound in desired shapes. For example, “parts with PFAS elastomer” is renamed as “O-rings with PFAS elastomer” if the desired shape is O-ring or halved O-ring.

As used herein, the term “parts with AEM elastomer” refers to parts manufactured with an AEM elastomer by for example: (1) preforming or extruding the AEM compound into desired shapes and (2) molding the AEM compound in desired shapes. For example, “parts with AEM elastomer” is renamed as “O-rings with AEM elastomer” if the desired shape is O-ring or halved O-ring. Constructed example of “parts with AEM elastomer” or “O-rings with AEM elastomer” is specified as set for in paragraph 146 of this specification.

As used herein, the term “parts with ACM elastomer” refers to parts manufactured with an ACM elastomer by for example (1) preforming or extruding the ACM compound into desired shapes and (2) molding the ACM compound in desired shapes. For example, “parts with ACM elastomer” is renamed as “O-rings with ACM elastomer” if the desired shape is O-ring or halved O-ring. Constructed example of “parts with ACM elastomer” or “O-rings with ACM elastomer” is specified as set for in paragraph 165 of this specification.

As used herein, the term “parts with EPDM elastomer” refers to parts manufactured with an EDPM elastomer by for example: (1) preforming or extruding the EPDM compound into desired shapes and (2) molding the EPDM compound in desired shapes. For example, “parts with EPDM elastomer” is renamed as “O-rings with EPDM elastomer” if the desired shape is O-ring or halved O-ring. Constructed example of “parts with EPDM elastomer” or “O-rings with EPDM elastomer” is specified as set for in paragraph 170 of this specification.

As used herein, the term “parts with HNBR elastomer” refers to parts manufactured with an HNBR elastomer by for example (1) preforming or extruding the HNBR compound into desired shapes and (2) molding the HNBR compound in desired shapes. For example, “parts with HNBR elastomer” is renamed as “O-rings with HNBR elastomer” if the desired shape is O-ring or halved O-ring. Constructed examples of “parts with HNBR elastomer” or “O-rings with HNBR elastomer” are specified as set for in paragraphs 153 and 160 of this specification. As used herein, the terms “parts with HNBR elastomer recipe 1001189” and/or “O-rings with HNBR elastomer recipe 1001189” refer to constructive examples of parts with Greene Tweed® recipe 1001189 HNBR elastomer and/or O-rings with Greene Tweed® recipe 1001189 HNBR elastomer specified as set for in paragraph 153 of this specification. As used herein, the terms “parts with HNBR elastomer recipe 1000597” and/or “O-rings with HNBR elastomer recipe 1000597” refer to constructive examples of parts with Greene Tweed® recipe 1000597 HNBR elastomer and/or O-rings with Greene Tweed® recipe 1000597 HNBR elastomer specified as set for in paragraph 160 of this specification.

As used herein, the terms “first bake-out process,” “first vacuum bake-out process,” and “pre-cured bake-out process” are interchangeable and refer to a vacuum bake-out process on the non-PFAS elastomer or PFAS elastomer before mixing the non-PFAS elastomer or PFAS elastomer with fillers and/or additives.

As used herein, the terms “second bake-out process,” “second vacuum bake-out process,” and “post-cured bake-out process” are interchangeable and refer to a vacuum bake-out process on the parts with non-PFAS elastomer or parts with PFAS elastomer after the parts with non-PFAS elastomer or parts with PFAS elastomer have been manufactured.

As used herein, the term “organic volatile” refers to organic outgassing having a mass-to-charge ratio between about 45 and about 100.

As used herein, the term “organic non-volatile” refers to organic outgassing having a mass-to-charge ratio between about 100 and about 200.

As used herein, the singular forms “a,” “an,” and “the” and similar referents in the context of describing the elements (especially in the context of the following claims) include plural references unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

Any use of section headings is intended to aid reading of the document and is not to be interpreted as limiting; information that is relevant to a section heading may occur within or outside of that particular section.

As used herein, the terms “for example,” “for instance,” “such as,” or “including” are meant to introduce examples that further clarify more general subject matter.

In the methods described herein, the acts can be carried out in a specific order as recited herein. Alternatively, in any aspect disclosed herein, specific acts may be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the scope of the claimed process.

### Seal

Seals have been widely used in various industries to resist harsh chemicals, extreme temperatures, and/or pressures. These industries include aerospace and defense, energy, semiconductor, industrial, and/or life sciences. Seals may have different shapes and functions and serve different industries. Articles described herein may include at least O-rings and backup rings, T-seals, gaskets, D-rings, Quad rings, rotary seals, V-rings, rod and piston seals, metal spring energized (MSE®) seals, custom shaped seals, and/or scraper and wiper seals.

O-rings and backup rings, for example, may be used either as a seal itself or as an energizing element in polytetrafluoroethylene (PTFE), cap-type seals in all above-mentioned industries. The O-rings may particularly have applications in aircraft engines, brakes, controls, semiconductor chamber seals, fuel controls, pumps, valves, hydraulic systems, oxygen systems, cryo coolers, and/or auxiliary power units (APUs).

The O-rings, as well as other seals, described herein are manufactured using elastomers and additives. Elastomers are typically polymers with viscoelasticity, weak intermolecular forces, generally low Young's modulus and high failure strain compared with other materials. The elastomers described herein certain non-PFAS elastomers. Additives include one or more of fillers, peroxide curatives, coagents, cure accelerators, processing aids, plasticizers, modifiers, colorants, organic dyes and/or pigments. Additives may be blended together with the elastomers to form the seals. Generally, the seals include the non-PFAS elastomer and the additives. The non-PFAS elastomers have a weight percentage from about 25% to about 99%, and preferably from about 30% to about 90%, or preferably from about 40% to about 80%, or preferably from about 50% to about 70%, or preferably from about 55% to about 65%. The additives have a weight percentage from about 1% to about 67%, and preferably from about 5% to about 60%, or preferably from about 10% to about 50%, or preferably from about 15% to about 40%, or preferably from about 20% to about 30%.

### Non-PFAS Elastomers

Per and polyfluoroalkyl substances (PFAS) are a group of synthetic organofluorine chemical compounds that have multiple fluorine atoms attached to an alkyl chain. For example, trifluoromethyl (—CF₃) group and difluoromethyl (—CF₂—) are commonly contained in PFAS. PFAS class includes both small molecules and large molecules, for example, fluoro-polymers and/or perfluoro-polymers. Examples of fluoro-polymers and/or perfluoro-polymers include but are not limited to fluoroelastomer (FKM), perfluoroelastomer (FFKM), and/or polytetrafluoroethylene (PTFE). The strong carbon-fluorine bond in PFAS (e.g., FKM, FFKM, and/or PTFE) increases sealing performance of PFAS.

The carbon-fluorine (C—F) bond is one of the strongest single covalent bonds. The C—F bond is resistant to both chemical and thermal attack. Fluorine atoms are very large by comparison to hydrogen atoms. When more hydrogen atoms in an organic alkyl compound are replaced with fluorine, the overall stability of that material increases due to the large fluorine atoms shielding other chemistry within the molecule from attack in addition to the individual C—F bond stability. Further, fluoropolymer materials containing C—F bonds have an exceptionally low coefficient of friction and are generally slippery. Fluoroplastics repel both water and oil making them beneficial as surfactants, water repellents, and non-stick surfaces.

In addition, PFAS generally has high plasma resistance, high heat resistance, high water resistance, high oil resistance, as well as longtime performance: The strength of the C—F bond means PFAS materials are resistant to degradation by acids, bases, oxidants, reductants, light, radiation, microbes and metabolic processes. These properties make fluoropolymer a product of choice when excellent chemical resistance, high thermal stability or extended lifetime are required in a sealing application.

However, PFAS raises global concern on human health regarding long-term impact of exposure to some PFAS. PFAS are included in the list of persistent “forever chemicals” and bio-accumulative. In United States, at least 21 states are considering restricting all uses of PFAS except those necessary for health and safety. Globally, governments are seeking to regulate the use of PFAS, which could lead to a ban on an entire PFAS class. The scope for the proposed PFAS regulation includes regulation on both small molecules and large molecules (e.g., polymers).

Embodiments of the present invention include elastomeric articles such as seals, gaskets, or components from non-PFAS polymers, fillers, cross-linkers and other additives. Examples of the non-PFAS polymers are polyethylene acrylate elastomers (AEM), polyacrylate elastomers (ACM), nitrile butadiene rubbers (NBR), hydrogenated nitrile butadiene rubbers (HNBR), ethylene propylene diene monomers (EPDM), ethylene propylene monomers (EPM), and the like. These examples of the non-PFAS polymers can be used alone or in combination thereof to such an extent not to impair the effect of the present invention.

Non-PFAS elastomer based seals and gaskets may be manufactured at lower cost relative to PFAS due to using lower cost non-PFAS raw materials and/or injection molding process or compression molding process used for PFAS-based seals.

Examples of the AEM elastomers are non-PFAS polymers with repeat units of at least an ethylene-based monomer and a methylacrylate-based monomer, and a cure site monomer. The ethylene-based monomer is a substituted or unsubstituted ethylene monomer. The substitution group represents a moiety selected from the group consisting of hydrogen, substituted or unsubstituted C₁-C₁₀ alkyl, substituted or unsubstituted C₂-C₁₀ alkenyl, substituted or unsubstituted aryl, and the like.

A general AEM structure (M¹) may have a substituted or unsubstituted ethylene monomer repeat unit, a substituted or unsubstituted alkylacrylate monomer repeat unit, and a cure site monomer unit:

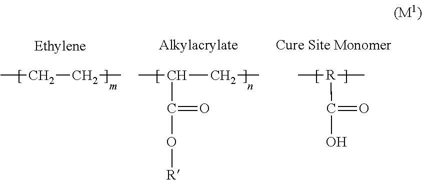

wherein the R′ moiety in alkylacrylate monomer repeat unit may be selected from the group consisting of substituted or unsubstituted C₁-C₁₂ alkyl; and wherein the R moiety in the cure site monomer unit may include a substituted or unsubstituted butanoic acid monoalkylester. Preferably, the R′ moiety is —CH₃ or —C₂H₅. Preferably, the R moiety is a methanetriyl group.

The substituted or unsubstituted ethylene monomer repeat unit may be from about 20 wt % to about 60 wt %, or preferably 25 wt % to about 60 wt %, or preferably from about 30 wt % to about 55 wt %, or preferably about 35 wt % to about 50 wt %, or preferably about 40 wt % to about 45 wt %. The ethylene monomer repeat units have good low temperature properties. Low temperature properties indicate polymer materials' performance on resistance to low temperature. In polymer materials, the long chain structure may slither over one another to keep the polymer materials flexible and render the polymer materials in “rubbery” states. However, as the temperature is decreased, polymer materials start to stiffen up and go through glass transition process to become effectively glassy solids with all the properties of glass. For example, the polymer materials may become hard and/or brittle. Generally speaking, the low temperature properties may be evaluated through the glass transition temperature (T_{g}) of the polymer materials. Polymer materials have better low temperature properties if they have a lower T_{g}. For example, the AEM elastomer described herein may have a T_{g} between about −30° C. and about 50° C., preferably between about −30° C. and about 40° C., or preferably between about −30° C. and about 30° C., or preferably between about −30° C. and about 20° C., or preferably between about −30° C. and about 10° C., or preferably between about −30° C. and about 0° C., or preferably between about −30° C. and about −10° C., or preferably between about −30° C. and about −20° C.

The substituted or unsubstituted alkylacrylate monomer repeat unit may be from about 35 wt % to about 75 wt %, or preferably from about 40 wt % to about 75 wt %, or preferably from about 45 wt % to about 70 wt %, or preferably from about 50 wt % to about 65 wt %, or preferably from about 55 wt % to about 60 wt %. The alkylacrylate monomer repeat units in the methyl acrylate monomer have improved swelling resistance in non-polar oils. Varying ethylene to alkyl acrylate ratio affects the end use performance of AEM based non-PFAS sealing applications. For example, increasing ethylene content increases heat resistance and reduces swelling resistance in oils whereas increasing acrylate content is required to enhance the oil resistance for end use applications. The AEM elastomer also has a small amount of carboxylated monomer containing carboxyl group.

The cure site monomers in the AEM elastomer are acidic monomers. Examples of cure site are iodine atom being present at the end of the trunk chain or side chain thereof (e.g., prepared by an iodine transfer polymerization method or the like), carboxyl group obtained by modifying a polymerization initiator such as ammonium persulfate, and cure site obtained by copolymerizing such a monomer providing cure site as mentioned above. Examples of such a monomer may include chlorovinyl ether, vinyl chloroacetate, allyl glycidyl ether, glycidyl methacrylate, other carboxy-functional comonomers, other epoxy-functional comonomers, other halogen-containing monomers, nitrile group-containing monomers, carboxyl group-containing monomers, alkoxycarbonyl group-containing monomers, and the like. The cure site monomers react with curative to cure the AEM elastomer and increase thermal stability as well as heat resistance.

The most common curatives are diamines or diamine carbamates. For example, hexamethylene diamine carbamate (HMDC) is a standard curative added to the AEM elastomer. If the AEM elastomer with HMDC is heated or exposed to moisture, the HMDC converts to hexamethylene diamine (HMDA) and carbon dioxide. The HMDA, which is the actual curative, reacts with the acidic cure site monomers in the AEM elastomers to form an amide bond. The amide bond provides dimensional stability to the AEM elastomer. In addition, the HMDA further reacts with the acidic cure site monomers in a postcure step to form an imide bond. The imide bond provides improved physical properties, compression set, improved thermal stability, and/or heat resistance to the AEM elastomer. In other examples, diamines or diamine carbamates may include N,N′-dicinnamylidene-1,6-hexanediamine and 4,4′-bis(aminocyclohexyl)methane carbamate.

In various embodiments of the present invention, the AEM elastomers described herein include a saturated backbone comprising a combination of ethylene-based monomer and methyl acrylate-based monomer. The saturated backbone provides high resistance to heat, as well as high resistance to ozone. The AEM elastomers described herein include polar side groups, which also provides high resistance to heat and/or ozone, on the repeat units in the methyl acrylate monomer.

Ozone is a colorless and toxic trace gas. Ozone makes up the ozone layer in our atmosphere and protects humans from harmful ultraviolet (UV) radiation. Ozone molecules each include three oxygen atoms and have the chemical formula of O₃. Ozone molecules are a strong and highly reactive oxidant. Polymers with unsaturated backbone are generally vulnerable to ozone and have lower resistance to ozone. The unsaturated, double bonds of the polymer backbone can be oxidized by ozone and break down as a result of oxidation. However, a saturated backbone in the polymers has single bond only, which has strong resistance to oxidation under room temperature and regular pressure.

In various embodiments of the present invention, the AEM elastomers described herein provide outstanding vibration damping and/or outstanding dynamic and abrasion properties over a wide temperature. According to American Society for Testing and Materials (ASTM) D2000 Type and Class EE standard, AEM may provide 70-hour heat aging at about 175° C. AEM may provide a change of tensile at plus or minus about 30%. AEM may provide a change of elongation at about −50% maximal elongation. AEM may provide a change of hardness for durometer at plus or minus about 15 points. For example, Vamac® VMX5000 series may provide high heat resistance up to about 190° C., excellent ozone and weather resistance, moderate resistance to mineral oils, low temperature flexibility to about −30° C., good resistance to hot water and high tensile strength up to about 20 MPa and elongation at break at about 350%.

In various embodiments of the present invention, the AEM elastomers described herein have applications in automotive industry (e.g., transmission and/or power steering), wires, cables, and the like.

Examples of commercially available AEM elastomers are VAMAC® HyPR 5000 series and VAMAC® Ultra series (previously known as VAMAC® 3000 series), both available from Celanese Corporation. VAMAC® HyPR 5000 series contains no halogens and generates low smoke upon burning.

Examples of the ACM elastomers are non-PFAS polymers with repeat units of at least an ethylacrylate monomer and a substituted ethylacrylate monomer. The substituted ethylacrylate monomer has one or more substitution group each selected from the group consisting of halogen, substituted or unsubstituted C₁-C₁₀ alkyl, substituted or unsubstituted C₂-C₁₀ alkenyl, substituted or unsubstituted aryl, and the like.

A general structure (M³) of ACM elastomers comprising multiple repeat units (e.g., repeat unit m and repeat unit n) is shown below:

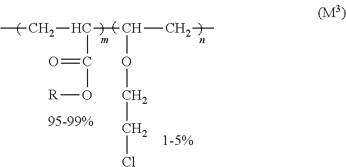

wherein R moiety may be selected from the group consisting of substituted or unsubstituted C₁-C₁₂ alkyl. Preferably, the R moiety is —CH₃, or —C₂H₅, or —C₄H₉, or —C₆H₁₃, or a combination of them. The repeat unit m may be from about 95 wt % to about 99 wt %, or preferably from about 96 wt % to about 98 wt %, or preferably from about 97 wt % to about 98 wt %. The repeat unit n may be from about 1 wt % to about 5 wt %, or preferably from about 2 wt % to about 4 wt %, or preferably from about 2 wt % to about 3 wt %.

In various embodiments of the present invention, the ACM elastomers described herein include a saturated backbone comprising repeat units of ethyl acrylate monomer. The ACM elastomers described herein also include polar side groups attached to the saturated backbone. A combination of the saturated backbone and the polar side groups provide high resistance to heat, oxidation and hydraulic oils, ozone, and/or weathering.

In various embodiments of the present invention, the ACM elastomers described herein have applications in automotive industry and transportation market due to high resistance to engine, transmission oil, automatic transmission fluids, and the like.

Examples of commercially available ACM elastomers are HyTemp® AR22 series available from Zeon Chemicals LP.

Examples of NBR are non-PFAS polymers are copolymers using acrylonitrile and butadiene monomers. Trade names of NBR may include Perbunan®, Nipol®, Krynac® and Europrene®. The NBR may be unusual in being resistant to oil, fuel, and/or other chemicals due to the presence of polar carbon-nitrogen triple bond. The general chemical structure (M¹) of NBR is shown below:

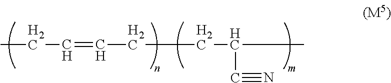

wherein m may be about 18 wt % to about 50 wt %, or preferably about 20 wt % to about 45 wt %, or preferably about 25 wt % to about 40 wt %, or preferably about 30 wt % to about 35 wt %.
Wherein n may be about 50 wt % to about 82 wt %, or preferably about 55 wt % to about 80 wt %, or preferably about 60 wt % to about 75 wt %, or preferably about 65 wt % to about 70 wt %.

Examples of HNBR are non-PFAS polymers with repeat units of at least a hydrogenated nitrile butadiene monomer. HNBR is classified as a high-temperature and oil-resistant elastomer. For example, HNBR is classified by American Society for Testing and Materials (ASTM) as a DH-type polymer, which means a service temperature of 150° C. and a less than 30% swelling in IRM 903 oil. The hydrogenated nitrile butadiene monomer may have a substituted or unsubstituted hydrogenated nitrile butadiene monomer. The substituted hydrogenated nitrile butadiene monomer has one or more substitution group, which is selected from the group consisting of halogen, substituted or unsubstituted C₁-C₁₀ alkyl, substituted or unsubstituted C₂-C₁₀ alkenyl, substituted or unsubstituted aryl, and the like, to replace hydrogen on the backbone.

A general structure (M⁴) of the HNBR elastomer in various embodiments of the present invention having the following substituted or unsubstituted repeat units (e.g., repeat unit m and repeat unit n, including hydrogenated nitrile butadiene monomer repeat unit) is shown as follows:

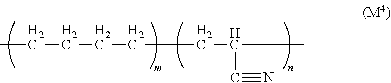

The number of the repeat unit m may be from about 50 wt % to about 85 wt %, preferably from about 55 wt % to about 80 wt %, or preferably from about 60 wt % to about 75 wt %, or preferably from about 65 wt % to about 70 wt %. The number of the repeat unit n may be from about 15 wt % to about 50 wt %, preferably from about 20 wt % to about 45 wt %, or preferably from about 25 wt % to about 40 wt %, or preferably from about 30 wt % to about 35 wt %. In various embodiments of the present invention, the HNBR elastomer may also include hydrogenated butadiene units. The weight percentage of hydrogenated butadiene units may be from about 0.9 wt % to about 1.9 wt %, preferably from about 1 wt % to about 1.8 wt %, or preferably from about 1.2 wt % to about 1.6 wt %, or preferably from about 1.3 wt % to about 1.5 wt %. Examples of commercially available HNBR may include ZETPOL® 3300 series, 4300 series, 3310 series, 4310 series, and/or 4320 series available from Zeon Chemicals LP.

Examples of EPDM are non-PFAS polymers with repeat units of at least an ethylene monomer, a propylene monomer, and a diene monomer. The ethylene monomer may be a substituted or unsubstituted ethylene monomer. The propylene monomer may be a substituted or unsubstituted propylene monomer. The diene monomer may be a substituted or unsubstituted diene monomer. The substituted ethylene/propylene/diene monomer has one or more substitution group, which is selected from the group consisting of halogen, substituted or unsubstituted C₁-C₁₀ alkyl, substituted or unsubstituted C₂-C₁₀ alkenyl, substituted or unsubstituted aryl, and the like, to replace hydrogen on the ethylene/propylene/diene monomer. A general structure (M⁶) of EPDM in various embodiments of the present invention containing a substituted or unsubstituted propylene monomer repeat unit, a substituted or unsubstituted ethylene monomer repeat unit, and a substituted or unsubstituted diene monomer repeat unit is shown as follow:

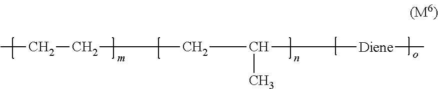

In EPDM rubber, the ethylene monomer repeat unit may be in the range of about 45 mol % to about 85 mol %, preferably about 50 mol % to about 80 mol %, or preferably about 55 mol % to about 75 mol %, or preferably about 60 mol % to about 70 mol %. The propylene monomer repeat unit may be in the range of about 15 mol % to about 55 mol %, preferably about 20 mol % to about 50 mol %, or preferably about 25 mol % to about 45 mol %, or preferably about 30 mol % to about 35 mol %. The diene unit may be in the range of about 1 mol % to about 12 mol %, preferably about 2 mol % to about 10 mol %, or preferably about 4 mol % to about 8 mol %, or preferably about 5 mol % to about 7 mol %. EPDM rubber has a glass transition temperature (T_{g}) at about −60° C. EPDM has molecular weight in the range of about 200,000 to about 300,000, preferably about 210,000 to about 290,000, or preferably about 220,000 to about 280,000, or preferably about 230,000 to about 270,000, or preferably about 240,000 to about 260,000, or preferably about 245,000 to about 255,000. The variety of diene monomers used in the manufacture of EPDM rubbers may include ethylidene norbornene (ENB), dicyclopentadiene (DCPD), vinyl norbornene (VNB), and/or 1,4 hexadiene (1,4 EHD).

Examples of commercially available EPDM are Keltan® 1000-9000 grade series available from ARLANXEO and Royalene® 525 series available from Lion Copolymer LLC.

Examples of EPM are non-PFAS polymers with repeat units of at least an ethylene monomer and a propylene monomer. The ethylene monomer may be a substituted or unsubstituted ethylene monomer. The propylene monomer may be a substituted or unsubstituted propylene monomer. The substituted ethylene/propylene monomer has one or more substitution group, which is selected from the group consisting of halogen, substituted or unsubstituted C₁-C₁₀ alkyl, substituted or unsubstituted C₂-C₁₀ alkenyl, substituted or unsubstituted aryl, and the like, to replace hydrogen on the ethylene/propylene monomer. A general structure (M⁷) of EPM in various embodiments of the present invention containing a substituted or unsubstituted propylene monomer repeat unit and a substituted or unsubstituted ethylene monomer repeat unit is shown as follow:

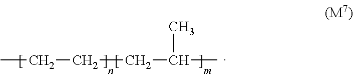

In EPM rubber, the ethylene monomer unit may be in the range of about 40 mol % to about 80 mol %, preferably about 45 mol % to about 75 mol %, or preferably about 50 mol % to about 70 mol %, or preferably about 55 mol % to about 65 mol %. The propylene unit may be in the range of about 20 mol % to about 60 mol %, preferably about 25 mol % to about 55 mol %, or preferably about 30 mol % to about 50 mol %, or preferably about 35 mol % to about 45 mol %.

### Vulcanization, Peroxide Curation and Cross-Linking

In various embodiments of the present invention, the non-PFAS polymers are vulcanized using peroxide and/or other coagent. For example, the peroxide may be 2,5-dimethyl-2,5-di-(tert-butylperoxy)hexane:

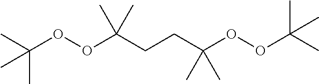 [SMILES: CC(C)(C)OOC(C)(C)CCC(C)(C)OOC(C)(C)C]

For example, the coagent may be triallyl iso-cyanurate (TAIC):

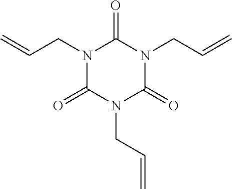 [SMILES: C=CCn1c(=O)n(CC=C)c(=O)n(CC=C)c1=O]

Peroxide-cured polymer systems include three key components: peroxide curative, TAIC co-curative, and non-PFAS polymers with halogen cure site monomer. In some embodiments, the halogen includes bromine and/or chlorine.

In the radical generation step, when the peroxide curative is heated at or above a given temperature, the peroxide curative decomposes to generate various reactive radical species. The various reactive radical species include but are not limited to alkoxyl radical and/or alkyl radical. The various reactive radical species then add to the TAIC co-curative to generate a new radical. For example, below illustrates this radical generation step when the peroxide curative is the above-mentioned 2,5-dimethyl-2,5-di-(tert-butylperoxy)hexane.

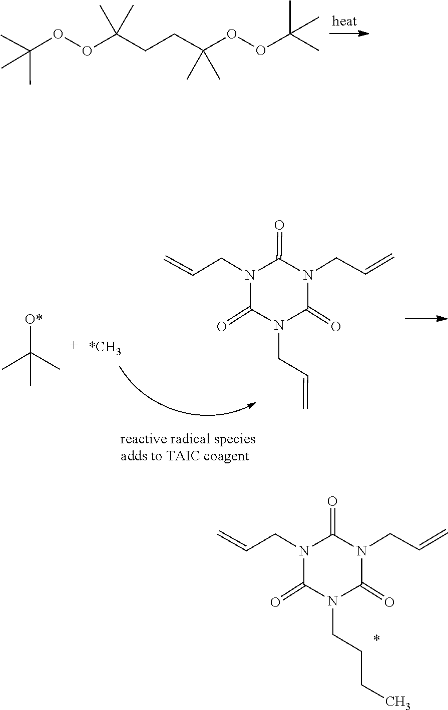

In the substitution step, the new radical reacts with the cure site monomer of the non-PFAS polymers and abstracts the halogen from the cure site monomer. Therefore, a non-PFAS polymer radical is formed under the substitution step.

In the cross-linking step, the non-PFAS polymer radical reacts with TAIC coagent in a repeatable process to form a cross-linked network product.

Other examples of antioxidants include AGERITE® SUPERFLEX® Solid G (e.g., a combination of diphenylamine-acetone reaction product, amorphous silica, and diphenylamine) available from Vanderbilt Chemicals and/or Vanox CDPA (bisphenylamine compound) also available from Vanderbilt Chemicals. Other examples of curing agents include Diak™-1 (e.g., (6-aminohexyl)carbamic acid) available from Chemours.

### Other Ingredients

The non-PFAS elastomer is mixed and blended with other ingredients to form a non-PFAS compound. In various embodiments of the present invention, fillers are required to be added into the non-PFAS elastomer composition at some point. Fillers to be blended to the non-PFAS elastomer composition of the present invention are silicon carbide (SiC) particles, carbon black, or a combination of both. Examples of commercially available SiC particles are NM SiC 99 series available from Nanomakers. Examples of commercially available carbon black are N330 series and N550 series. Other fillers that may be added into the composition include silica, barium sulfate, carbon (e.g., nano carbon tube), clay, talc, metallic fillers (e.g., titanium oxide, aluminum oxide, yttrium oxide, silicon oxide), metal carbides (silicon carbide, aluminum carbide), metallic nitrides (e.g., silicon nitride, aluminum nitride), and the like. For example, fillers having preferred shielding plasma effects include aluminum oxide, yttrium oxide, silicon oxide and/or polyimide. Fillers may also include organic fillers such as polyether ether ketone (PEEK), polyaryl ether ketone (PAEK), nylon, and the like.

It is preferable that these silicon carbide/carbon black fine articles (nano particles) are formed, for example, by a pulverization method using a pulverizer such as jet mill or by a method of forming powders by core generation from an atom or a molecule and its growth. In the latter case, the method is classified into a vapor phase method, a liquid phase method and a solid phase method depending on a state of a starting material, and for example, nano particles of silicon carbide/carbon black formed by plasma chemical vapor growth method are known.

In various embodiments of the present invention, additives other than fillers/peroxide curatives/coagents may also be mixed into the non-PFAS elastomer composition. Additives are optional and not required. However, if desired to alter certain properties, the additives described herein may include one or more of activators, cure accelerators, processing aids, plasticizers, and modifiers. In addition, colorants, organic dyes and/or pigments may also be used as additives to be mixed into the non-PFAS elastomer composition. For example, pigmented fillers, which are preferred for heat resistance and chemical resistance and having less effect on end characteristics of the molded articles, include quinacridone, diketopyrrolopyrrole and anthraquinone pigments and dyes, with quinacridone being preferred. Examples of activators include stearic acid. Examples of accelerator include Vulcofac® ACT55 (e.g., a combination of 1,8-diazabicyclo(5.4.0)undec-7-ene and silica) available from Chemtrec and/or RHEONOGRAN® XLA-60 (e.g., a combination of synergistic combination of activated amine with retarder and acrylic copolymer and dispersing agents). Examples of processing aids include VANFRE® VAM (polyoxyethylene octadecyl ether phosphate) available from Vanderbilt Chemicals. Examples of plasticizers include Alcanplast® P080 (monomeric ester) available from CHEMSPEC.

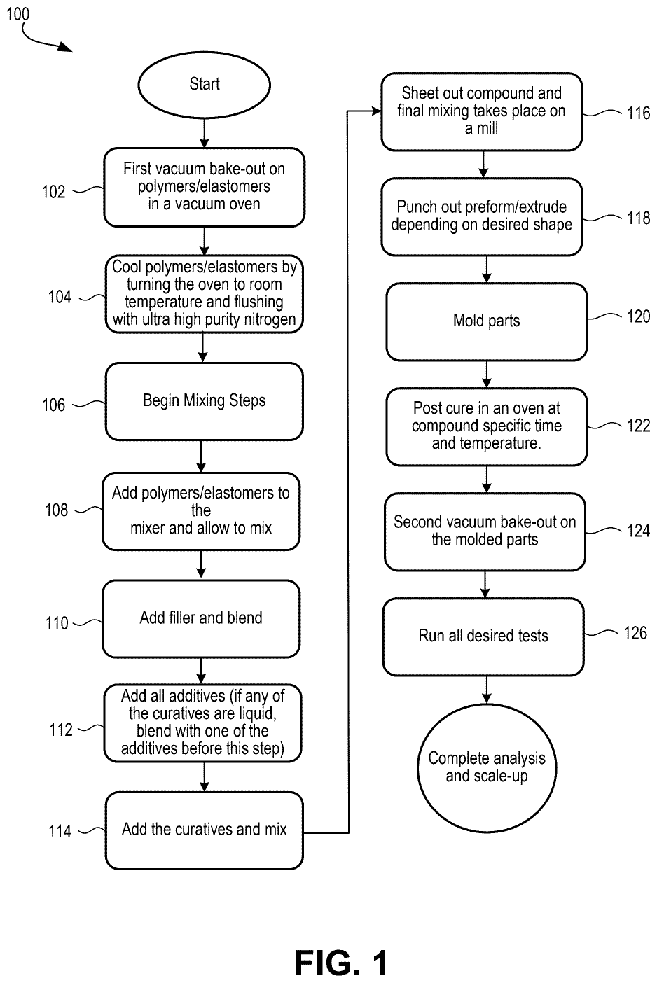

FIG. 1 is a flow diagram illustrating an example compounding process 100 starting with 100 grams of non-PFAS material for making the non-PFAS compounds and testing the performance. At 102, non-PFAS polymers (e.g., ACM, AEM, HNBR, NBR, EPM, EPDM, etc.) are baked out under the first bake-out process in a vacuum oven under a temperature range of about 75° C. to about 175° C. preferably at about 110° C. for a period of 1 to 30 days preferably for a period of 168 hours. At 104, the non-PFAS polymers are cooled by turning the oven to room temperature and/or flushing with ultra-high purity nitrogen.

In mixing steps 106, various materials are added to a mixer in the following order: The non-PFAS polymers are added to a mixer and mixed for a given period of time from about 1 minute to about 15 minutes (e.g., 1 minute) at 108. Fillers are added to the mixer and blended for a few minutes at 110. Additives are added to the mixer and blended at 112. Curatives and co-curatives are also added to the mixer and mixed for a given period of time from about 1 minute to about 15 minutes (e.g., 1 minute) at 114. However, if at least one curative is liquid, the liquid curative may be blended with one of the additives before step 112. In some embodiments of the present invention, processing aids, colorants, and/or antioxidants are also added to mix with the non-PFAS compound.

After the mixing steps 106, the non-PFAS compound is sheeted out and mixed in a mill at 116. The non-PFAS compound is turned into preform at 118. For example, the preform may either be an extrudate, or slug depending on the desired shape of the parts having the non-PFAS compound.

The parts having the non-PFAS compound are molded at a given temperature such as 350-356° F. for a given frequency such as 10-minute cycles at 120. At 122, the parts having the non-PFAS compound are post-cured at the non-PFAS compound-specific time and temperature in an oven. The parts having the non-PFAS compound are baked out under the second bake-out process for a given temperature from about 75° C. to about 175° C. (e.g., preferably 110° C.) under a given period of time from about 1 day to about 30 days (e.g., preferably 7 days) at 124. After the second bake-out process, the parts having the non-PFAS compound are tested for desired tests (e.g., outgassing, physical property tests, heat resistance test, etc.) at 126.

In various embodiments of the present invention, an outgassing test is conducted to test the outgas behavior of parts such as O-rings. The outgassing test may be a residual gas analysis (RGA) test, which is conducted under a constant temperature for a given period of time. For example, the RGA test is conducted under 150° C. for 480 minutes. The RGA test is taken using a residual gas analyzer, which is a small and usually rugged mass spectrometer, typically designed for process control and contamination monitoring in vacuum systems. The outgas behavior is evaluated by pressure of volatiles in millibar per second per square centimeter in the unit of mbar*l/s/cm².

In one example, three kinds of O-rings with non-PFAS elastomers described herein were tested for outgas behavior under 150° C. for 480 minutes along with an O-ring with a PFAS elastomer after a vacuum-bake out process. The three kinds of O-rings with non-PFAS elastomers described herein included O-ring with AEM elastomer and O-ring with HNBR elastomer. The O-ring with PFAS elastomer was used as a control group and includes O-ring with FKM elastomer. In various embodiments described herein, O-rings may be pre-baked at a temperature between room temperature (e.g., about 25° C.) and about 150° C. for a time period less than or equal to about 168 hours. The O-rings may be either single bagged, or triple bagged for outgassing tests. In a single bagging situation, the article or the O-ring is vacuum sealed using KNF™ cleanroom polyethylene bag. In a triple bagged situation, the article or O-ring sample is wrapped in ultra-high vacuum aluminum foil with a thickness of 0.001 inch that meets ASTM 8478 standard. The wrapped article or O-ring is sealed using a first KNF™ cleanroom polyethylene bag (i.e., inner bag). The first vacuum sealed KNF™ cleanroom polyethylene bag is heat sealed using a second DRIERITE™ desiccant bag (i.e., middle bag), and the heat sealed second DRIERITE™ desiccant bag is heat sealed using a third KNF™ cleanroom polyethylene bag (i.e., outer bag). Three certain categories of outgas were tested in the RGA test, which includes H₂O (mass-to-charge ratio equals to about 18), organic volatile CₓH_{y} (e.g., mass-to-charge ratio no less than about 45 and no more than about 100), and organic non-volatile CₓH_{y} (e.g., mass-to-charge ratio no less than about 101 and no more than about 200). Low CₓH_{y} outgas level is an important characteristic for the O-ring with non-PFAS elastomer. For example, in extreme ultraviolet lithography (EUVL, also known simply as EUV), extreme ultraviolet light is used to create intricate patterns on silicon wafers. High level CₓH_{y} outgas may contaminate the EUV mirrors and reduce reflectivity of the EUV mirrors. Therefore, O-rings with non-PFAS elastomers having a low CₓH_{y} outgas level may be desired in the EUVL industry.

RGA outgassing tests for the O-rings were carried out using gas chromatography mass spectrometry (GC-MAS) test method under vacuum and subtracting the background. After 480 minutes, the results of the outgas behaviors through RGA test are summarized as follows:

| | | Organic | Organic |
|---|---|---|---|
| | | volatile | non-volatile |
| | H₂O | CₓH_{y} | CₓH_{y} |
| O-rings with PFAS | 8.65*10⁻⁸ | 1.01*10⁻⁸ | 2.47*10⁻⁹ |
| (FKM) | (mbar*l/s/cm²) | (mbar*l/s/cm²) | (mbar*l/s/cm²) |
| O-rings with AEM | 5.98*10⁻⁸ | 5.00*10⁻⁹ | 1.47*10⁻⁹ |
| Elastomer | (mbar*l/s/cm²) | (mbar*l/s/cm²) | (mbar*l/s/cm²) |
| O-rings with HNBR | 4.96*10⁻⁷ | 5.20*10⁻⁸ | 1.42*10⁻⁷ |
| Elastomer (recipe | (mbar*l/s/cm²) | (mbar*l/s/cm²) | (mbar*l/s/cm²) |
| 1001189, single | | | |
| bagged, without | | | |
| prebaking) | | | |
| O-rings with HNBR | 2.57*10⁻⁸ | 2.17*10⁻¹⁰ | 5.00*10⁻¹² |
| Elastomer (recipe | (mbar*l/s/cm²) | (mbar*l/s/cm²) | (mbar*l/s/cm²) |
| 1001189, triple | | | |
| bagged, without | | | |
| prebaking) | | | |
| O-rings with HNBR | 8.09*10⁻⁹ | 1.57*10⁻⁹ | 2.59*10⁻¹⁰ |
| Elastomer (recipe | (mbar*l/s/cm²) | (mbar*l/s/cm²) | (mbar*l/s/cm²) |
| 1001189, single | | | |
| bagged, two-hour pre- | | | |
| baking at 120° C.) | | | |
| O-rings with HNBR | 3.60*10⁻⁹ | 7.02*10⁻¹⁰ | 3.30*10⁻¹¹ |
| Elastomer (recipe | (mbar*l/s/cm²) | (mbar*l/s/cm²) | (mbar*l/s/cm²) |
| 1001189, triple | | | |
| bagged, two-hour pre- | | | |
| baking at 120° C.) | | | |
| O-rings with HNBR | 1.15*10⁻⁷ | 9.37*10⁻⁹ | 6.64*10⁻¹⁰ |
| Elastomer (recipe | (mbar*l/s/cm²) | (mbar*l/s/cm²) | (mbar*l/s/cm²) |
| 1000597) | | | |

Specifically, the O-ring with AEM elastomer displayed better outgas behavior (e.g., lower outgas) than the O-ring with FKM elastomer control group. Generally, a desired outgas behavior includes a pressure of organic volatiles (e.g., organic volatile and organic non-volatile) in millibar per second per square centimeter less than or equal to about 4*108 (mbar*l/s/cm²). Therefore, both the O-ring with AEM elastomer and the O-ring with HNBR elastomer behaved a desired outgas behavior. In addition, triple bagged treatment and pre-baking treatment on HNBR elastomer improved outgas behavior (e.g., lowered outgas).

Specifically, residual gas released from the non-PFAS compound comprises organic volatiles in millibar per second per square centimeter less than or equal to about 5.2*10⁻⁸ (mbar*l/s/cm²) as measured by an outgassing test. Preferably, residual gas released from the non-PFAS compound comprises organic volatiles in millibar per second per square centimeter less than or equal to about 9.37*10⁻⁹ (mbar*l/s/cm²) as measured by an outgassing test, or preferably less than or equal to about 5.00*10⁻⁹ (mbar*l/s/cm²), or preferably less than or equal to about 1.57*10⁻⁹ (mbar*l/s/cm²), or preferably less than or equal to about 7.02*10⁻¹⁰ (mbar*l/s/cm²). Most preferably, residual gas released from the non-PFAS compound comprises organic volatiles in millibar per second per square centimeter less than or equal to about 2.17*10⁻¹⁰ (mbar*l/s/cm²) as measured by an outgassing test.

Specifically, residual gas released from the non-PFAS compound comprises organic non-volatiles in millibar per second per square centimeter less than or equal to about 1.42*10⁻⁷ (mbar*l/s/cm²) as measured by an outgassing test. Preferably, residual gas released from the non-PFAS compound comprises organic non-volatiles in millibar per second per square centimeter less than or equal to about 1.47*10⁻⁹ (mbar*l/s/cm²) as measured by an outgassing test, or preferably less than or equal to about 6.64*10⁻¹⁰ (mbar*l/s/cm²), or preferably less than or equal to about 2.59*10⁻¹⁰ (mbar*l/s/cm²), or preferably less than or equal to about 3.30*10⁻¹¹ (mbar*l/s/cm²). Most preferably, residual gas released from the non-PFAS compound comprises organic non-volatiles in millibar per second per square centimeter less than or equal to about 5.00*10⁻¹² (mbar*l/s/cm²) as measured by an outgassing test.

Duration of the vacuum bake-out process may affect the outgas behavior. The duration of the vacuum bake-out process (e.g., the second bake-out process) may include one or more iterations of bake-out. For example, the duration of a vacuum bake-out process with three iterations may be in the order of a 1^{st} iteration, a 2^{nd} iteration and a 3^{rd} iteration. Different iteration in the same vacuum bake-out process may be conducted under different conditions. In various embodiments of the present invention, the latter iteration (e.g., the 3^{rd} iteration) may take longer time than prior iterations (e.g., the 2^{nd} iteration) in the same vacuum bake-out process.

For example, O-rings with AEM elastomer under different iterations (e.g., 2^{nd} iteration and 3^{rd} iteration which has longer vacuum bake-out durations than the first iteration) in the second vacuum bake-out process were tested for outgas behavior through RGA test. RGA outgassing tests for the O-rings were carried out using GC-MAS test method under vacuum and subtracting the background. In the 2^{nd} iteration, the O-rings with AEM elastomer were tested under 175° C. for 24 hours. In the 3^{rd} iteration, the O-rings with AEM elastomer were tested under 175° C. for 168 hours. The outgas behavior results are summarized as follows:

| | | Organic | Organic |
|---|---|---|---|
| O-rings with AEM | | volatile | non-volatile |
| Elastomer | H₂O | CₓH_{y} | CₓH_{y} |
| 2^{nd} iteration | 8.96*10⁻⁸ | 2.26*10⁻⁸ | 2.66*10⁻⁹ |
| | (mbar*l/s/cm²) | (mbar*l/s/cm²) | (mbar*l/s/cm²) |
| 3^{rd} iteration | 5.98*10⁻⁸ | 5.0*10⁻⁹ | 1.47*10⁻⁹ |
| | (mbar*l/s/cm²) | (mbar*l/s/cm²) | (mbar*l/s/cm²) |
| Percentage lower from | 44% | 88% | 45% |
| 2^{nd} iteration to 3^{rd} | | | |
| iteration | | | |

For another example, the same O-rings with HNBR elastomer under different iterations (e.g., 2^{nd} iteration and 3^{rd} iteration) in the second vacuum bake-out process were tested for outgas behavior through RGA test. RGA outgassing tests for the O-rings were carried out using GC-MAS test method under vacuum and subtracting the background. In the 2^{nd} iteration, the O-rings with HNBR elastomer were tested under 175° C. for 24 hours. In the 3^{rd} iteration, the O-rings with HNBR elastomer were tested under 175° C. for 168 hours. The outgas behavior results are summarized as follows:

| O-rings with HNBR | | Organic | Organic |
|---|---|---|---|
| Elastomer (recipe | | volatile | non-volatile |
| 1000597) | H₂O | CₓH_{y} | CₓH_{y} |
| 2^{nd} iteration | 6.18*10⁻⁹ | 4.03*10⁻⁸ | 1.82*10⁻⁹ |
| | (mbar*l/s/cm²) | (mbar*l/s/cm²) | (mbar*l/s/cm²) |
| 3^{rd} iteration | 1.15*10⁻⁷ | 9.37*10⁻⁹ | Not detected |
| | (mbar*l/s/cm²) | (mbar*l/s/cm²) | |
| Percentage lower from | N/A | 77% | N/A |
| 2^{nd} iteration to 3^{rd} | | | |
| iteration | | | |

After the 3^{rd} iteration, the outgas behavior of both the O-rings with AEM elastomer and the O-rings with HNBR elastomer improved by at least 44%.

### Performances

In various embodiments of the present invention, O-rings with non-PFAS elastomers display good physical properties. For example, O-rings with non-PFAS elastomers display better physical properties than the physical properties of O-rings with PFAS elastomers (e.g., O-rings with FKM elastomer). The physical properties discussed herein include tensile behavior, compression set (e.g., tested under 150° C. for 22 hours), and/or sticking force (e.g., tested under 150° C. for 22 hours).

The compression set of a material is the permanent deformation remaining after compressing it. The compression set is normally measured in two ways: compression set A and compression set B. Compression set A has the formal name “compression set under constant force in air,” and is defined as the percentage of original specimen thickness after the specimen has been left in normal (e.g., uncompressed) condition for 30 minutes. Compression set B has the formal name “compression set under constant deflection in air” and is defined as the percentage of specimen deflection after it has been left in normal (e.g., uncompressed) condition for 30 minutes. Compression testing was performed according to ASTM standard D395-18.

Generally speaking, materials with a low compression set may maintain their original shape and properties over an extended period and within expected loading limits. This means the materials with a low compression set can withstand cyclic and heavy compressive forces without permanent deformation. Materials with a low compression set may have an outstanding ability to maintain seal pressure over time and prevent leaks, product failure, and/or hazards. Materials with a low compression set may help absorb and damp out vibrations, which reduces the likelihood of equipment failure or damage in high-speed and potentially overloaded systems. Materials with a low compression set may be used in medical, automotive, aerospace, semiconductor, energy applications and the like. Materials with a low compression set may provide a cushioning effect and reduce the likelihood of injury and/or discomfort.

In one example, four kinds of O-rings with non-PFAS elastomers described herein were tested for compression set under 150° C. for 22 hours along with an O-ring with PFAS elastomer. The four kinds of O-rings with non-PFAS elastomers described herein include O-ring with ACM elastomer, O-ring with AEM elastomer, O-ring with EPDM elastomer, and/or O-ring with HNBR elastomer. The O-ring with PFAS elastomer was used as a control group and included O-ring with FKM elastomer. After 22 hours, the O-ring with AEM elastomer had compression set of about 15%, the O-ring with ACM elastomer had compression set of about 26%, the O-ring with HNBR elastomer had compression set of about 15%, and the O-ring with EPDM elastomer had compression set of about 33%. Meanwhile, the O-ring with FKM elastomer had a compression set of about 32%. Therefore, under the current temperature (150° C.) and time period (22 hours), all four kinds of O-rings with non-PFAS elastomers described herein performed better than or about equal to the O-ring with PFAS elastomer control group.

Sticking force, also known as adhesive force, refers to the attractive forces that hold two materials together at their surface. A desired seal may have a low sticking force, which allows less damage to the seal when opening or closing doors with seals. The stick force test was conducted according to the following method: The sticking force was measured on O-rings. An O-ring was compressed (e.g., preferably compressed 25%) in a jig between two stainless steel plates. The jig was placed in an air oven for a period of time (e.g., preferably about 24 hours) at a desired temperature (e.g., preferably about 392° F.). The plates of the heated-treated jig were attached to a material testing machine (e.g., an Instron machine) and the force required to pull the plates apart was measured. The measured force required to pull the plates apart is recorded as the stick force.

In one example, four kinds of O-rings with non-PFAS elastomers described herein were tested for sticking force under 150° C. for 22 hours along with an O-ring with PFAS elastomer. The four kinds of O-rings with non-PFAS elastomers tested were the O-ring with ACM elastomer, O-ring with AEM elastomer, O-ring with EPDM elastomer, and/or O-ring with HNBR elastomer. The PFAS elastomer was used as a control group and included FKM elastomer. After 22 hours at a temperature of 150° C., the O-ring with AEM elastomer had sticking forces of about 0 N, the O-ring with ACM elastomer had sticking forces of about 53 N, the O-ring with HNBR elastomer had sticking forces of about 40 N, the O-ring with EPDM elastomer had sticking forces of about 120 N, and the O-ring with FKM elastomer had a sticking force of about 267 N. Therefore, under the current temperature (150° C.) and time period (22 hours), all four kinds of O-rings with non-PFAS elastomers described herein performed better than the O-ring with PFAS elastomer control group. Especially, the O-ring with AEM elastomer, which had a sticking force close to 0 N, performed the best among all materials tested.

Rubber-to-metal bonding test under ASTM D429-14 standard (e.g., ASTM D429-14e1 (Method A) are designed for testing the adhesion of rubber to rigid metal substrates and whether failure is at the bond or in the material. The purpose of rubber-to-metal bonding test is to ensure that the bonded component is strong enough to perform its intended function. The rubber-to-metal bonding test is generally conducted during vulcanization by bonding the non-PFAS compounds to metal substrate (e.g., aluminum substrate and/or stainless steel substrate preferably in disk shape). Before the rubber-to-metal bonding test, the metal substrate surface was blasted (e.g., using a glove-box type grit blaster), cleaned by using a solvent such as alcohol, and wiped to remove solvent residual. During the rubber-to-metal bonding test, the non-PFAS compounds were cut into a 2 square inch samples and sandwiched between two metal disks. Forces were applied to the metal disks to pull on the metal disks to determine whether failure would occur at the bond or in the non-PFAS elastomer. The rubber-to-metal bonding test may be repeated multiple times (e.g., 4 times) to reduce bias and/or measurement error. The rubber-to-metal bonding test may be completed at various temperatures for a given period of time. For example, the various temperatures may preferably include room temperature (e.g., about 23° C.), about 100° C., or about 200° C. The given period of time may preferably include 1 hour or 16 hours.

Samples were tested according to the ASTM D429-14 standard. In one example, three kinds of non-PFAS compounds described herein as well as two PFAS compounds control groups were tested for rubber-to-metal bonding under room temperature (e.g., about 23° C.). For example, the three non-PFAS compounds described herein include AEM compounds and HNBR compounds. The two PFAS compounds control groups included bisphenol cure type 1 FKM (PFAS control group 742) compound and peroxide cure type 2 FKM (PFAS control group F07) compound. All non-PFAS compounds and PFAS compounds had been conditioned at room temperatures for 16 hours before being tested under room temperature. Each non-PFAS compounds and PFAS compounds were cut into 2 inch squares and tested four times. The results of the test were as follows. The first bar for each compound is for aluminum substrates and the second bar is for stainless steel substrates.

The average bond strength maximal force on aluminum substrate is shown as follows:

| | Average bond strength |
|---|---|
| | maximal force on |
| Compounds | aluminum substrate (lbs) |
| PFAS 742 compounds (Bisphenol | 1457.78 |
| Cure Type 1 FKM) | |
| AEM compounds | 1317.70 |
| HNBR compounds (Recipe 1001189) | 982.21 |
| HNBR compounds (Recipe 1000597) | 1368.06 |
| PFAS F07 compounds (Peroxide | 1360.35 |
| Cure Type 2 FKM) | |

The average bond strength maximal force on stainless steel substrate is shown as follows:

| | Average bond strength |
|---|---|
| | maximal force on |
| Compounds | stainless steel substrate (lbs) |
| PFAS 742 compounds (Bisphenol | 1304.52 |
| Cure Type 1 FKM) | |
| AEM compounds | 1111.86 |
| HNBR compounds (Recipe 1001189) | 1155.33 |
| HNBR compounds (Recipe 1000597) | 1180.53 |
| PFAS F07 compounds (Peroxide | 1232.75 |
| Cure Type 2 FKM) | |

There were two failure descriptions on the breakage of elastomers under pressure: interface failure (RC) and/or rubber failure (R). Interface failure is a more desired failure description, and elastomers with larger percentage of interface behave a better tensile performance compared to elastomers with larger percentage of rubber failure. The failure descriptions of the described above as well as the two O-rings with PFAS elastomer control groups are summarized as follows:

| | Aluminum | Stainless Steel |
|---|---|---|
| Compound with PFAS control | 10% RC, 90% R | 10% RC, 90% R |
| group (742) | | |
| AEM Compound (non-PFAS) | 100% RC | 100% RC |
| HNBR Compound Recipe | 100% RC | 100% RC |
| 1001189 (non-PFAS) | | |
| HNBR Compound Recipe | 100% RC | 100% RC |
| 1000597 (non-PFAS) | | |
| Compound with PFAS control | 60% RC, 40% R | 100% RC |
| group (F07) | | |

The two kinds of O-rings with non-PFAS elastomers had more interface failures, while the 0-rings with PFAS elastomer control groups had more rubber failures. The O-rings with non-PFAS elastomers had similar failure descriptions under aluminum test and stainless steel test.

Tensile properties refer to how a material behavior when subjected to tensile (e.g., pulling) stress. Tensile properties include tensile strength, elongation at failure, and the like. A higher tensile strength indicates a better property against tensile stress. Elongation at failure is the percentage of elongation of the material when the material is broken. A higher elongation at failure indicates a better stretching property. Tensile testing was conducted according to ASTM standard D1414-94.

In one example, four O-rings with non-PFAS elastomers described herein were tested for tensile strength and elongation at failure along with an O-ring with PFAS elastomer. All five O-rings with elastomers were cured before the test. The four kinds of O-rings with non-PFAS elastomers described herein included an O-ring with an ACM elastomer, an O-ring with an AEM elastomer, an O-ring with an EPDM elastomer, and an O-ring with an HNBR elastomer. The O-ring with a PFAS elastomer was used as a control group and included an O-ring with FKM elastomer.

The O-ring with ACM elastomer had a tensile strength of about 12 MPa and elongation at failure of about 407%. The O-ring with an AEM elastomer had a tensile strength of about 13.6 MPa and elongation at failure of about 186%. The O-ring with EPDM elastomer had a tensile strength of about 25 MPa and an elongation failure of about 353%. The O-ring with HNBR elastomer had a tensile strength of about 15.4 MPa and an elongation failure of about 131%. The O-ring with FKM elastomer in the control group had a tensile strength of about 16.6 MPa and an elongation at failure of about 299%. Therefore, under the current test, tensile properties of O-rings with non-PFAS elastomers vary as the formations are different from each other. The spread of tensile properties for O-rings with non-PFAS elastomers is manageable since the range is not wide. In addition, the tensile properties for O-rings with non-PFAS elastomers may be tailored to desired value to meet the end use performance requirements for different applications. The tensile properties were acceptable.

In another example, three kinds of O-rings with non-PFAS elastomers described herein as well as two O-rings with PFAS elastomer control groups were tested under room temperature for mean tensile stress at maximum loads. For example, the two O-rings with PFAS elastomer control groups included an O-ring with bisphenol cure type 1 FKM (PFAS control group 742) and an O-ring with a peroxide cure type 2 FKM (PFAS control group F07). The mean tensile stress at maximum loads was evaluated by the mean tensile stress that breaks 100% of tested elastomers. Tensile strength at break was measured using ASTM D1414 standard test method. The maximum loads tested included a maximum load of aluminum and/or a maximum load of stainless steel are summarized as follows:

| | Aluminum | Stainless Steel |
|---|---|---|
| O-ring with PFAS control | ~720 Psi | ~640 Psi |
| group (742) | | |
| Bisphenol Cure Type 1 FKM | | |
| O-ring with AEM | ~660 Psi | ~560 Psi |
| elastomer (non-PFAS) | | |
| O-ring with HNBR elastomer | ~488 Psi | ~575 Psi |
| Recipe 1001189 (non-PFAS) | | |
| O-ring with HNBR elastomer | ~690 Psi | ~590 Psi |
| Recipe 1000597 (non-PFAS) | | |
| O-ring with PFAS control | ~690 Psi | ~610 Psi |
| group (F07) | | |
| Peroxide Cure Type 2 FKM | | |

The three kinds of O-rings with non-PFAS elastomers gave comparable tensile performance to the O-ring with PFAS elastomer (F07) control group.

In various embodiments of the present invention, the O-rings with non-PFAS elastomers display good heat resistance. For example, the O-rings with non-PFAS elastomers display better heat resistance than the heat resistance of O-rings with PFAS elastomers (e.g., 0-rings with FKM elastomer). The heat resistance discussed herein include results of heat resistance tests under multiple different conditions, including preferably at least a test under 150° C. for 70 hours and/or a test under 175° C. for 24 hours.

Heat resistance may be evaluated under various parameters, including change in hardness, change in tensile strength, change in elongation, and the like. Generally, according to ASTM 2000 and SAE J200 standards, a material is deemed to have good heat resistance if: (1) the change in hardness of the material is less than or equals to 15 points, (2) the change in tensile strength of the material is less than or equals to 30%, and/or (3) the change in elongation of the material is less than or equals to 50%, after aging 70 hours at a specific temperature.

In one example, four kinds of O-rings with non-PFAS elastomers described herein were tested for heat resistance under 150° C. for 70 hours. The four kinds of O-rings with non-PFAS elastomers tested were the O-ring with ACM elastomer, O-ring with AEM elastomer, O-ring with EPDM elastomer, and/or O-ring with HNBR elastomer. After the 70 hours, the O-ring with ACM elastomer had a change in hardness of about 4 points, a change in tensile strength of about 4%, and a change in elongation of about 22%. The O-ring with AEM elastomer had a change in hardness of about 7 points, a change in tensile strength of about 1%, and a change in elongation of about 3%. The O-ring with EPDM elastomer had a change in hardness of about 3 points, a change in tensile strength of about 2%, and a change in elongation of about 21%. The O-ring with HNBR elastomer had a change in hardness of about 5 points, a change in tensile strength of about 14%, and a change in elongation of about 0%. Under ASTM 2000 and SAE J200 standards, all four O-rings with non-PFAS elastomers displayed good heat resistance under 150° C.

In various embodiments of the present invention, the non-PFAS compounds were tested for and displayed good permeation properties. For example, the non-PFAS compounds display better permeation properties than the permeation properties of PFAS compounds (e.g., FKM compounds). The permeation properties discussed herein include results of helium permeation test under 23° C. using ASTM D1434 instruments.

Permeability is a property of material that is an indication of the ability for fluids (e.g., gas or liquid) to flow through the material. Fluids can more easily flow through a material with high permeability than the material with low permeability. Permeability may be an absolute permeability or a relative permeability compared to a certain standard.

In one example, four kinds of non-PFAS compounds described herein were tested for permeability along with a PFAS compound. The four kinds of non-PFAS compounds tested were the ACM compound, AEM compound, EPDM compound, and/or HNBR compound. The PFAS compound was used as a control group and includes FKM compound. The permeation test used was a gas permeation test using helium as the fluid under room temperature (e.g., 23° C.). Helium (He), compared to other gases such as nitrogen (N₂) or oxygen (O₂), has the smallest molecule size. The smaller molecule size of Helium may permeate more easily through seals, which allows for a more accurate “worst case” test scenario to achieve a higher degree of testing results. The helium permeation test was conducted under about 23° C. and about 15 psi gas pressure for about 48 hours. The relative permeability of the four non-PFAS compounds ranged from 1 (AEM compound) to 1.5 (HNBR compound) to 2.4 (ACM compound/EPDM compound). On the other side, the relative permeability of the PFAS compound was 2.4. Therefore, the AEM compound and HNBR compound displayed better helium permeability compared to the PFAS compound control group.

Halved O-rings were tested for plasma resistance. In various embodiments of the present invention, the O-rings with non-PFAS elastomers display good plasma resistance. For example, the O-rings with non-PFAS elastomers displayed better plasma resistance than the plasma resistance of O-rings with PFAS elastomers (e.g., O-ring with FKM elastomer). Percentage of weight change is used to evaluate the plasma resistance. The percentage of weight change equals to the change in weight of the seal after exposure to plasma over the weight of the seal before plasma exposure. A lower percentage of weight change indicates a better plasma resistance. The plasma resistance discussed herein include results of percentage of weight lost after exposure to NF₃/O₂ plasma for about 6 hours at about 200° C.

NF₃/O₂ plasma resistances are one of the main concerns in semiconductor manufacturing. In semiconductor manufacturing process, there is a wet process for washing a wafer by using ozone (O₃) water. Accordingly, sealing materials are required to be stable in not only NF₃ plasma treatment but also O₃ treatment.

However, fillers such as silica and titanium oxide are stable in O₃ treatment but are subject to decomposition in NF₃ plasma treatment, resulting in weight reduction. On the other hand, fillers such as carbon black and PTFE powder are stable in NF₃ plasma treatment but are subject to decomposition in ozone treatment, resulting in weight reduction.

In order to eliminate the above-mentioned problems, blending fillers such as compounds having a specific surface area of not less than 0.5 m²/g and containing an aromatic ring and non-oxide fillers such as boride, carbides (e.g., silicon carbide), nitrides, silicides, sulfides, and/or phosphides are used.

In one example, the NF₃ and/or O₂ Plasma resistance for O-Rings were measured using ASTM D1414 test method. Various halved O-rings with non-PFAS elastomers/PFAS elastomers were exposed to NF₃ plasma for 6 hours at 200° C. The various halved O-rings were manufactured by making compounds separately for each non-PFAS seals with fillers and other additives. Fillers and other additives were the same for all halved O-rings described herein. The O-rings with non-PFAS elastomers included an O-ring with ACM elastomer, an O-ring with AEM elastomer, an EPDM elastomer, and/or an HNBR elastomer. The O-ring with PFAS elastomer was also tested as a control group. After 6 hours of exposure, halved O-rings with non-PFAS elastomers had a percentage of weight change ranging from 0.44% to 1.88%, while the halved O-ring with PFAS elastomer had a percentage of weight change at 11.55%. Detailed remote NF₃ plasma resistance results are summarized as follows:

| Elastomers in halved O-rings | Percentage of weight change |
|---|---|
| ACM (non-PFAS) | 0.77% |
| AEM (non-PFAS) | 1.88% |
| EPDM (non-PFAS) | 0.44% |
| HNBR Recipe 1001189 (non-PFAS) | 1.948% |
| HNBR Recipe 1000597 (non-PFAS) | 0.88% |
| PFAS | 11.55% |

The remote NF₃ plasma resistance results show that non-PFAS elastomers performed better than the PFAS elastomer control group when used in the halved O-rings. The non-PFAS elastomers had a weight change less than or equal to about 2% after a six-hour remote NF₃ plasma exposure.

Multiple iterations of the second vacuum bake-out process on the O-rings with non-PFAS elastomers may also affect the NF₃ plasma resistance of the halved O-rings with non-PFAS elastomers. For example, the temperatures and time lengths for multiple iterations of the second vacuum bake-out process on the O-ring with AEM elastomer are summarized as follows:

| O-ring with AEM elastomer | Temperature | Time length | |
|---|---|---|---|
| 1^{st} iteration | 175° C. | 4 | hours |
| 2^{nd} iteration | 175° C. | 24 | hours |
| 3^{rd} iteration | 175° C. | 168 | hours |

For another example, the temperatures and time lengths for multiple iterations of the second vacuum bake-out process on the O-ring with HNBR elastomer are summarized as follows:

| O-ring with HNBR elastomer | | | |
|---|---|---|---|
| Recipe 1000597 | Temperature | Time length | |
| 1^{st} iteration | 149° C. | 1 | hour |
| 2^{nd} iteration | 175° C. | 24 | hours |
| 3^{rd} iteration | 175° C. | 168 | hours |

Under same experimental conditions (e.g., same remote NF₃ plasma for 6 hours), remote NF₃ plasma resistance results for O-rings with AEM/HNBR elastomer after 3^{rd} iteration of the second vacuum bake-out process and same O-rings with AEM/HNBR elastomer after 1^{st} iteration of the second vacuum bake-out process are summarized as follows:

| Elastomers in | Percentage of weight | Percentage of weight |
|---|---|---|
| halved O-rings | change after 1^{st} iteration | change after 3^{rd} iteration |
| AEM Elastomer | 1.88% | 1.60% |
| HNBR Elastomer | 0.88% | 1.63% |
| Recipe 1000597 | | |

There was no significant improved NF₃ plasma resistance for O-ring with AEM elastomer and O-ring with HNBR elastomer after 3^{rd} iteration of the second vacuum bake-out process.

In another example, various halved O-rings with non-PFAS elastomers/PFAS elastomers were exposed to O₂ plasma for 6 hours at 200° C. The O-rings with non-PFAS elastomers included an O-ring with an AEM elastomer and an O-ring with an HNBR elastomer. The O-ring with PFAS elastomer was also tested as a control group. All the O-rings with non-PFAS elastomers used herein underwent the duration of three iterations in the second vacuum bake-out process mentioned above. The 02 plasma exposure used herein comprises a remote plasma exposure. After 6 hours of exposure, halved O-rings with non-PFAS elastomers had a percentage of weight change ranging from 2.87% to 16.44%, while the halved O-ring with PFAS elastomer had a percentage of weight change at 3.94%. Detailed remote O₂ plasma resistance results are summarized as follows:

| | Percentage of |
|---|---|
| Elastomers in halved O-rings | weight change |
| AEM (non-PFAS) Elastomer | 16.44% |
| HNBR (non-PFAS) Elastomer Recipe 1001189 | 8.663% |
| HNBR (non-PFAS) Elastomer Recipe 1000597 | 2.87% |
| PFAS Elastomer | 3.94% |

The remote O₂ plasma resistance results show that the O-ring with HNBR elastomer performed the best in resisting O₂ plasma.

Similarly, multiple iterations of the second vacuum bake-out process on the 0-rings may also affect the O₂ plasma resistance of the halved O-rings with non-PFAS elastomers. For example, under same experimental conditions (e.g., same remote O₂ plasma under 200° C. for 6 hours), remote O₂ plasma resistance results for O-rings with AEM/HNBR elastomer after 3^{rd} iteration of the second vacuum bake-out process and the same O-rings with AEM/HNBR elastomer after 1^{st} iteration of the second vacuum bake-out process are summarized as follows:

| Elastomers in | Percentage of weight | Percentage of weight |
|---|---|---|
| halved O-rings | change after 1^{st} iteration | change after 3^{rd} iteration |
| AEM Elastomer | 24.95% | 16.44% |
| HNBR Elastomer | 4.46% | 2.87% |
| Recipe 1000597 | | |

O₂ plasma resistance for O-ring with AEM elastomer and O-ring with HNBR elastomer after 3^{rd} iteration of the second bake-out process showed improvement.

### EXAMPLES

### Example 1: AEM Non-PFAS Compound and Parts with AEM Non-PFAS Elastomer

The AEM non-PFAS compounding process started with a first vacuum bake-out at 28 inches of Hg of Vamac® HyPR 5020 AEM polymer and Vamac® Ultra EV AEM polymer at 110° C. for 168 hours. After the first bake-out period was complete, the polymer was cooled, and the vacuum chamber was filled with ultra-high purity nitrogen.

Following the first bake-out was the mixing process. The two polymers were first blended with a part per hundred rubber (phr) of 150 (for Vamac® HyPR 5020) and 30 (for Vamac® Ultra EV) respectively on an internal mixer for one minute. 15 phr of NM SiC99 @35 nm filler was then added into the mixer.

Following the filler, the additive and processing aids were mixed into the compound. The additive and processing aids included Agerite® Superflex Solid G at 1.5 phr, Industrene® R at 0.5 phr, and Vanfre® Vam at 1 phr in no order.

Lastly, the curatives, which included Vulcofac® ACT-55 and Vulcofac® HDC, were added at 2 phr (for Vulcofac® ACT-55) and 0.9 phr (for Vulcofac® HDC) respectively. The compound was mixed for 1 minute and then removed from the internal mixer. After being mixed, the compound was sheeted out using a two-roll mixing mill.

The compound was then turned into preform. The preform was either an extrudate, or slug depending on the desired shape of the parts, by using an extruder or a clicking die. The preform was molded and cured at 356° F. for 10 minutes. After being molded, the parts were placed in an oven for post-cure at 347° F. for 4 hours.

After being post-cured, the parts were placed in the vacuum oven for a second and final vacuum bake-out at 110° C. for 168 hours. The parts were again cooled under ultra-high purity nitrogen until reaching room temperature. After cooled, the parts were placed in a vacuum sealed bag for storage or shipping.

The recipe for the AEM non-PFAS compound and parts with AEM non-PFAS elastomer was as follows:

| | Ingredient | (PHR) Parts per | Weight |
|---|---|---|---|
| Ingredient Name | Category | Hundred Rubber | percentage |
| VAMAC ® HyPR 5020 | Polymer | 150 | 74.66% |
| Vamac ® Ultra EV | Polymer | 30 | 14.93% |
| VULCOFAC ® ACT-55 | Curative | 2 | 1% |
| VULCOFAC ® HDC | Curative | 0.9 | 0.45% |
| NM SIC99@ 35 nm | Filler | 15 | 7.47% |
| AGERITE ® SUPERFLEX | Additive | 1.5 | 0.75% |
| SOLID G | | | |
| Industrene ® R | Additive | 0.5 | 0.25% |
| Vanfre ® Vam | Processing | 1 | 0.5% |
| | Aid | | |

### Example 2: HNBR Non-PFAS Compound and Parts with HNBR Non-PFAS Elastomer (Recipe 1001189)

The HNBR non-PFAS compounding process started with a first vacuum bake-out of Zetpol®2020 HNBR polymer at 110° C. for 168 hours. After the first bake-out period was complete, the polymer was cooled, and the vacuum chamber was filled with ultra-high purity nitrogen.

Following the first bake-out was the mixing process. 100 phr of the polymer was mixed by itself on an internal mixer for one minute. 35 phr of NM SiC99®35 nm filler was then added into the mixer and blended for about 3 minutes.

Following the filler, 5 phr of Elastomag®170 was premixed with 3 phr of TP-95 by hand. The premixed ingredients were added to the mixer. Following the premixed ingredients included mixing the rest of the additives, which included 2 phr of Naugard®445, 2 phr of Vanox® ZMTI, and 3 phr of WB®42, in no order.

The remaining curatives, which included 8 phr of TAIC DLC® A and 8 phr of Varox® DBPH-50, were added and mixed for 1 minute until all ingredients were combined. The combined compound was removed from the internal mixer. After being mixed, the compound was sheeted out using a two-roll mixing mill.

The compound was then turned into preform. The preform was either an extrudate, or slug depending on the desired shape of the parts, by using an extruder or a clicking die. The preform was molded and cured at 350° F. for 10 minutes. After being molded, the parts were post-cured at 300° F. for 1 hour. The post-curing time ramped up to 300° F. for another 30 min. The parts were held for 1 hour, cooled for 30 min, and then dried in the vacuum oven at 28 inches of Hg for a second and final vacuum bake-out at 110° C. for 168 hours. The parts were again cooled under ultra-high purity nitrogen until reaching room temperature. After cooled, the parts were placed in a vacuum sealed bag for storage or testing.

The recipe for the HNBR non-PFAS compound and parts with HNBR non-PFAS elastomer (recipe 1001189) was as follows:

| | Ingredient | (PHR) Parts per | Weight |
|---|---|---|---|
| Ingredient Name | Category | Hundred Rubber | percentage |
| Zetpol ® 2020 | Polymer | 100 | 60.24% |
| Elastomag ® 170 | Polymer | 5 | 3.01% |
| TAIC DLC ®-A | Curative | 8 | 4.82% |
| Varox ® DBPH-50 | Curative | 8 | 4.82% |
| NM SIC99@ 35 nm | Filler | 35 | 21.08% |
| NAUGARD ® 445 | Additive | 2 | 1.20% |
| TP-95 ® | Additive | 3 | 1.81% |
| VANOX ® ZMTI | Additive | 2 | 1.20% |
| WB ® 42 | Additive | 3 | 1.81% |

### Example 3: HNBR Non-PFAS Compound and Parts with HNBR Non-PFAS Elastomer (Recipe 1000597)

The HNBR non-PFAS compounding process started with a first vacuum bake-out of Zetpol®4310 HNBR polymer at 110° C. for 168 hours. After the first bake-out period was complete, the polymer was cooled, and the vacuum chamber was filled with ultra-high purity nitrogen.

Following the first bake-out was the mixing process. 100 phr of the polymer was mixed by itself on an internal mixer for one minute. 75 phr of NM SiC99 @35 nm filler was then added into the mixer and blended for about 3 minutes.

Following the filler, 5 phr of Elastomag® 170 was premixed with 3 phr of TP-95 by hand. The premixed ingredients were added to the mixer. Following the premixed ingredients included mixing the rest of the additives, which included 2 phr of Naugard®445, 2 phr of Vanox® ZMTI, and 3 phr of WB®42, in no order.

The remaining curatives, which included 8 phr of TAIC DLC® A and 8 phr of Varox® DBPH-50, were added and mixed for 1 minute until all ingredients were combined. The combined compound was removed from the internal mixer. After being mixed, the compound was sheeted out using a two-roll mixing mill.

The compound was then turned into preform. The preform was either an extrudate, or slug depending on the desired shape of the parts, by using an extruder or a clicking die. The preform was molded and cured at 350° F. for 10 minutes. After being molded, the parts were post-cured at 300° F. for 1 hour. The post-curing time ramped up to 300° F. for another 30 min. The parts were held for 1 hour, cooled for 30 min, and then dried in the vacuum oven at 28 inches of Hg for a second and final vacuum bake-out at 110° C. for 168 hours. The parts were again cooled under ultra-high purity nitrogen until reaching room temperature. After cooled, the parts were placed in a vacuum sealed bag for storage or testing.

The recipe for the HNBR non-PFAS compound and parts with HNBR non-PFAS elastomer (recipe 1000597) was as follows:

| | Ingredient | (PHR) Parts per | Weight |
|---|---|---|---|
| Ingredient Name | Category | Hundred Rubber | Percentage |
| Zetpol ® 4310 | Polymer | 100 | 48.54% |
| Elastomag ® 170 | Polymer | 5 | 2.43% |
| TAIC DLC ®-A | Curative | 8 | 3.88% |
| Varox ® DBPH-50 | Curative | 8 | 3.88% |
| NM SIC99@ 35 nm | Filler | 75 | 36.41% |
| NAUGARD ® 445 | Additive | 2 | 0.97% |
| TP-95 ® | Additive | 3 | 1.46% |
| VANOX ® ZMTI | Additive | 2 | 0.97% |
| WB ® 42 | Additive | 3 | 1.46% |

### Example 4: ACM Non-PFAS Compound and O-Ring with ACM Non-PFAS Elastomer

The ACM non-PFAS compounding process started with adding 100 phr of HyTemp® AR22 ACM polymer in a Brabender mixer and mixing for 1 minute. Then 60 phr of NM SiC99 @35 nm filler was added into the mixer and mixed for about 10-20 minutes.

Following the filler, the additive and processing aids were mixed into the compound. The additive and processing aids included 1 phr of Industrene® R, 2 phr of Vanox®CDPA, and 0.5 phr of Vanfre® VAM in no order and the compound was mixed for 3 minutes. Then 1 phr of VulcoFac® ACT 55 was added and mixed for 1 minute. Finally, 0.6 phr of Vulcofac® HDC was added and mixed for 3 minutes.

The compound was added to tight mill for cutting and bending for 3 minutes. The mill was opened to 50, passed once through rolls and dropped. The compound was molded for 8 minutes at 374° F. and post-cured at 347° F. in air for 4 hours, and then cooled for 30 minutes. After post-curing, 214 O-Rings with ACM non-PFAS elastomer were made from the compound and tested for performance.

The recipe for the ACM non-PFAS compound and O-ring with ACM non-PFAS elastomer was as follows:

| | Ingredient | (PHR) Parts per | Weight |
|---|---|---|---|
| Ingredient Name | Category | Hundred Rubber | percentage |
| HyTemp ® AR22 | Polymer | 100 | 60.57% |
| VULCOFAC ® ACT-55 | Curative | 1 | 0.61% |
| VULCOFAC ® HDC | Curative | 0.6 | 0.36% |
| NM SIC99@ 35 nm | Filler | 60 | 36.34% |
| INDUSTRENE ® R | Additive | 1 | 0.61% |
| VANOX ® CDPA | Additive | 2 | 1.21% |
| VANFRE ® VAM | Processing Aid | 0.5 | 0.30% |

### Example 5: EPDM Non-PFAS Compound and O-Ring with EPDM Non-PFAS Elastomer

The EPDM non-PFAS compounding process started by blending 50 phr Keltan®2470S EPDM polymer and 50 phr of Royalene®525 EPDM polymer in a Brabender mixer and mixing for 1 minute. Then 75 phr of NM SiC99 @35 nm filler was added into the mixer and mixed for about 10-20 minutes.

Following the filler, the additive and processing aids were mixed into the compound. The additive and processing aids included 1 phr of Naugard®445 G, 2 phr of Agerite® RD Powder, and 1.5 phr of Vanfre® APD in no order and were mixed for 2 minutes. Then 1.5 phr of Saret®515 was added to the compound and the compound was mixed for 2 minutes. Finally, 3.2 phr of Varox® DBPH was added and mixed for 3 minutes.

The compound was added to tight mill for cutting and bending for 3 minutes. The mill was opened to 6.7 mm, passed once through rolls and dropped. The compound was molded for 10 minutes at 350° F. and post-cured at 300° F. in air by ramping for 20 minutes to 300° F. and holding 1 hour at 300° F. The compound was then cooled for 30 minutes. After post-curing, 214 O-Rings with EPDM non-PFAS elastomer were made from the compound and tested for performance.

The recipe for the EPDM non-PFAS compound and O-ring with EPDM non-PFAS elastomer was as follows:

| | Ingredient | (PHR) Parts per | Weight |
|---|---|---|---|
| Ingredient Name | Category | Hundred Rubber | percentage |
| KELTAN ®2470S | Polymer | 50 | 26.64% |
| ROYALENE ® 525 | Polymer | 50 | 26.64% |
| Varox ® DBPH | Curative | 3.2 | 1.70% |
| NM SIC99@ 35 nm | Filler | 75 | 39.96% |
| NAUGARD ®445 | Additive | 1 | 0.53% |
| AGERITE ® RD POWDER | Additive | 2 | 1.07% |
| SARET ® SR515 | Additive | 5 | 2.66% |
| VANFRE ® APD | Processing | 1.5 | 0.80% |
| | Aid | | |

The manufacturing processes for all four examples of non-PFAS compounds and parts (e.g., O-ring) with non-PFAS elastomer followed the generic process displayed in FIG. 1 with some slight variations.

1. An article comprising at least non-PFAS elastomers and additives,
wherein the non-PFAS elastomers comprise at least one of a polyacrylate elastomer (ACM), a polyethylene acrylate elastomer (AEM), an ethylene propylene monomers (EPM) elastomer, an ethylene propylene diene monomer (EPDM) elastomer, a nitrile butadiene rubber (NBR), or a hydrogenated nitrile butadiene rubbers (HNBR) elastomer;
wherein the non-PFAS elastomers have a weight change less than or equal to about 2% after a six-hour remote NF₃ plasma exposure;
wherein the additives comprise fillers comprising at least one of carbon black, silicon carbide, silica, barium sulfate, carbon, clay, talc, metallic fillers, metallic nitrides, and organic fillers; wherein the organic fillers comprising polyether ether ketone (PEEK), polyaryl ether ketone (PAEK), or nylon;
wherein the non-PFAS elastomers have a weight percentage of a total weight of the article from about 25% to about 99%; and
wherein the additives have a weight percentage of the total weight of the article from about 1% to about 67%.

2. The article according to claim 1, wherein the additives further comprise one or more of a curative, a coagent, a cure accelerator, a processing aid, a plasticizer, a modifier, a colorant, an organic dye, or a pigment.

3. The article according to claim 1, wherein the AEM comprises an ethylene monomer repeat unit, a substituted or unsubstituted alkylacrylate monomer repeat unit, and a cure site monomer unit; the AEM having the following formula (M¹): 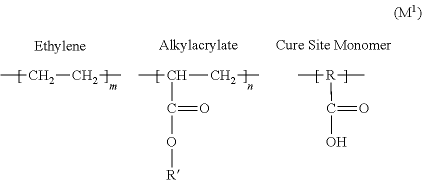
wherein R represents a moiety selected from a substituted or unsubstituted butanoic acid monoalkylester moiety, wherein R′ represents a moiety selected from the group consisting of substituted or unsubstituted C₁-C₁₂ alkyl;
wherein m is defined such that the ethylene monomer repeat unit is from about 20% to about 60% by weight of the AEM; and
wherein n is defined such that the substituted or unsubstituted alkylacrylate monomer repeat unit is from about 35% to about 75% weight of the AEM.

4. The article according to claim 1, wherein the ACM comprises an ethylacrylate monomer repeat unit and a second repeat unit; the ACM having the following formula (M³): 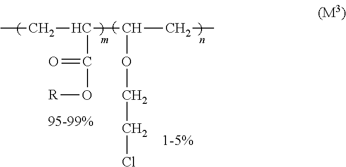
wherein R represents a moiety selected from the group consisting of substituted or unsubstituted C₁-C₁₂ alkyl;
wherein m is defined such that the ethylacrylate repeat unit is from about 95% to about 99% by weight of the ACM; and
wherein n is defined such that the second repeat unit is from about 1% to about 5% by weight of the ACM.

5. The article according to claim 1, wherein the HNBR elastomer comprises a first repeat unit and a second repeat unit; the HNBR elastomer having the following formula (M⁴): 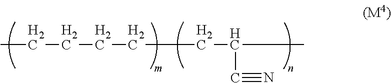
wherein the first repeat unit has a first number “m”, and wherein the second repeat unit has a second number “n”;
wherein the first number “m” of the first repeat unit is defined such that the first repeat unit is from about 50% to about 85% by weight of the HNBR elastomer; and
wherein the second number “n” of the second repeat unit is defined such that the second repeat unit is from about 15% to about 50% by weight of the HNBR elastomer.

6. The article according to claim 1, wherein the NBR comprises a first repeat unit and a second repeat unit; the NBR having the following formula (M⁵): 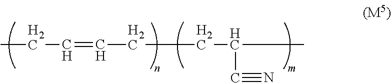
wherein the first repeat unit has a first number “n”, and wherein the second repeat unit has a second number “m”;
wherein the first number “n” is defined such that the first repeat unit is from about 50% to about 82% by weight of the NBR; and
wherein the second number “m” is defined such that the second repeat unit is from about 18% to about 50% by weight of the NBR.

7. The article according to claim 1, wherein the EPDM elastomer comprises an ethylene monomer repeat unit, a propylene monomer repeat unit, and a diene monomer unit; the EPDM elastomer having the following formula (M⁶): 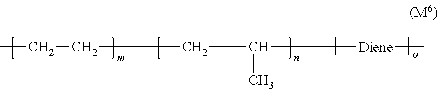
wherein m is defined such that the ethylene monomer repeat unit is from about 45 mol % to about 85 mol % of the EPDM elastomer;
wherein n is defined such that the propylene monomer repeat unit is from about 15 mol % to about 55 mol % of the EPDM elastomer; and
wherein o is defined such that the diene monomer unit is from about 1 mol % to about 12 mol % of the EPDM elastomer.

8. The article according to claim 1, wherein the EPM elastomer comprises an ethylene monomer repeat unit, and a propylene monomer repeat unit; the EPM elastomer having the following formula (M⁷): 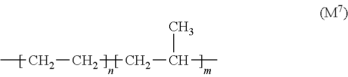
wherein n is defined such that the ethylene monomer repeat unit is from about 40 mol % to about 80 mol % of the EPM elastomer; and
wherein m is defined such that the propylene monomer repeat unit is from about 20 mol % to about 60 mol % of the EPM elastomer.

9. The article according to claim 1, wherein an H₂O outgas behavior of the article is less than or equal to about 8.65*10⁻⁸ mbar*l/s/cm², and wherein an organic volatile outgas behavior of the article is less than or equal to about 1.01*10⁻⁸ mbar*l/s/cm², and wherein an organic non-volatile outgas behavior of the article is less than or equal to about 2.47*10⁻⁹ mbar*l/s/cm².

10. The article according to claim 1, wherein a remote NF₃ plasma resistance of the article comprises a percentage of weight change less than or equal to about 1.88%.

11. The article according to claim 1, wherein the article comprises an O-ring, a T-seal, a gasket, a D-ring, a Quad ring, or a custom-shaped seal.

12. The article according to claim 1, wherein the article has about 100% interface failure (RC) on a breakage of elastomers under aluminum pressure or stainless-steel pressure.

13. A manufacturing method of an article comprising the steps of:
conducting a first vacuum bakeout of a two-step vacuum bakeout process on non-PFAS elastomers to remove volatiles from the non-PFAS elastomers;
mixing the non-PFAS elastomers with one or more of a curative, a co-curative, or fillers in an internal mixer or a two-roll rubber mill to form non-PFAS compounds;
mixing one or more of processing aids, colorants, or antioxidants with the non-PFAS compounds; and
conducting a second vacuum bakeout process of the two-step vacuum bakeout process on the non-PFAS compounds to remove volatiles from the non-PFAS compounds.

14. The manufacturing method of claim 13, further comprising:
testing the non-PFAS elastomers, the non-PFAS compounds, or parts having the non-PFAS compounds for outgassing.

15. The manufacturing method of claim 13, wherein residual gas released from the non-PFAS compound comprises organic volatiles in millibar per second per square centimeter less than or equal to about 5.2*10⁻⁸ (mbar*l/s/cm²) as measured by an outgassing test.

16. The manufacturing method of claim 13, wherein residual gas released from the non-PFAS compound comprises organic volatiles in millibar per second per square centimeter less than or equal to about 2.17*10⁻¹⁰ (mbar*l/s/cm²) as measured by an outgassing test.

17. The manufacturing method of claim 13, wherein residual gas released from the non-PFAS compound comprises organic non-volatiles in millibar per second per square centimeter less than or equal to about 1.42*10⁻⁷ (mbar*l/s/cm²) as measured by an outgassing test.

18. The manufacturing method of claim 13, wherein residual gas released from the non-PFAS compound comprises organic non-volatiles in millibar per second per square centimeter less than or equal to about 5.00*10⁻¹² (mbar*l/s/cm²) as measured by an outgassing test.

19. The manufacturing method of claim 13, wherein the article comprises an O-ring, a T-seal, a gasket, a D-ring, a Quad ring, or a custom-shaped seal.

20. A method of forming an article between a first component and a second component comprising compressing a sealing composition comprising the non-PFAS elastomer and the additives according to claim 1 between the first component and the second component.

21. A method of forming the article according to claim 1, wherein the article comprises an O-ring, a T-seal, a gasket, a D-ring, a Quad ring, or a custom-shaped seal.
